(19) United States
(12) Patent Application Publication
(10) Pub. No.: US 2005/0194814 A1
(43) Pub. Date: Sep. 8, 2005

(54) Drop down door support system

(75) Inventors: Daniel G. Willis, Portland, OR (US); Ron W. Phillips, Sandy, OR (US); Benjamin R. Hein, Portland, OR (US)

Correspondence Address: KLARQUIST SPARKMAN, LLP, 121 SW SALMON STREET, SUITE 1600, PORTLAND, OR, 97204, US

(73) Assignee: SNF, Inc.

(21) Appl. No.: 11/006,847

(22) Filed: Dec. 7, 2004

Related U.S. Application Data
(60) Provisional application No. 60/550,536, filed on Mar. 3, 2004.

(51) Int. Cl. B62D 33/03

(52) U.S. Cl. 296/146.1

(57) ABSTRACT

A drop down door system for a vehicle in which a door is pivotally connected adjacent its lower edge margin for swinging between closed and open positions relative to a door opening framed at opposite sides by door jamb members. Elongate tension springs extend between the doorjamb members and opposite edge margins of the door. The doorjamb members have elongate channels for receiving the retracted springs, which channels are covered by portions of the door when it is closed. Hinge mechanism for the door is provided by aligned hinge sleeves on the door and door frame with an elongate hinge pin extending therethrough which has stop mechanism thereon for inhibiting movement of the pin from its selected assembled position.

### CROSS REFERENCE TO RELATED APPLICATION

This application claims the benefit of U.S. Provisional Application No. 60/550,536, filed on Mar. 3, 2004, which is incorporated herein by reference.

### FIELD OF INVENTION

This invention relates to a drop down door support system for a vehicle.

### BACKGROUND OF THE INVENTION

Vehicles, including recreation vehicles, often have various compartments which are accessed by a variety of types of doors. One such type of door is a drop down door which is hingedly connected for swinging down about a substantially horizontally disposed pivot axis to allow access to a region within the vehicle.

More specifically, such drop down doors system may be provided for a storage area within the vehicle and the drop down door which is pivotally connected adjacent its lower edge margin may be swung downwardly to provide a ramp for loading equipment into the storage region of the vehicle. The door then may be swung upwardly to a substantially vertical position to close the doorway opening.

Various styles of door assist systems have been provided in the past. Some of these have included elongated tension springs connected at one end to the drop down door and at their opposite end to the vehicle in a region spaced above the door hinge. The spring acts to help control lowering of the weight of the door, or opening, and on closing of the spring serves to assist the user to lift the door to its closed position.

In the past, various systems have been proposed for mounting and enclosing such tension springs, but such have not been fully successful.

Another feature of a drop down door system is the use of pivot connections between the lower edge margin of the door and the vehicle frame. Again, a variety of forms of pivot connections have been attempted, but not all have been successful in providing the ease of assembly and structural characteristics desired.

### SUMMARY OF THE INVENTION

An aspect of the present invention is to provide a novel drop down door system for a vehicle in which an elongate tension spring is provided to assist in lowering and raising of the door, and which provides a receiving region in which the tension spring is held when the door is closed.

More specifically, an aspect of the invention is to provide such a novel drop down door system in which a side jamb of the door system has a receiving channel formed therein adapted to receive the tension spring when the door is raised, or closed, and the combination of channel and closed door provide an enclosed receptacle for the tension spring. This provides both a protective enclosure for the spring and its attachments, and a pleasing aesthetic appearance when the door is closed.

Another aspect of the invention is to provide a novel hinge system for the door in which the door and its associated mounting frame have a pair of aligned cylindrical pin-receiving sleeves which are axially aligned and a cylindrical hinge pin is received therein. The hinge pin has a head which extends outwardly from one end of one of the sleeves and mechanism is provided for inhibiting removal of the pin.

A more specific aspect of the invention is to provide such a novel hinge system wherein a support member adjacent one end of one of the sleeves has an assembly bore extending therethrough, through which the hinge pin maybe inserted to enter the receiving sleeves, and after the hinge pin has been extended through the assembly bore a securing device may be removably attached to inhibit removal of the pin through the base.

These and other aspects of the invention will become more fully apparent as the following description is read in conjunction with the drawings.

### BRIEF DESCRIPTION OF THE DRAWINGS

FIG. 1 is a perspective view of a rear end of a vehicle on which a drop down door system according to an embodiment of the invention is illustrated in a closed position;

FIG. 2 is a view similar to FIG. 1, in which a drop down door system according to an embodiment of the present invention is shown in an open position;

FIG. 3 is an enlarged view of the rear end of the vehicle with the door open as in FIG. 2, with a center portion removed to allow side-to-side compression in the drawing, and a major portion of the door broken away for illustrative purposes;

FIG. 3A is an enlarged cross-sectional view taken along the line of 3A in FIG. 3 showing the door in a closed position and the orientation of a tension spring received in a channel in a doorjamb assembly;

FIG. 4 is an enlarged cross-sectional view taken generally along the line 4-4 in FIG. 3;

FIG. 5 is a view taken generally along the line 5-5 in FIG. 4;

FIG. 6 is an enlarged cross-sectional view of a portion of the hinge assembly on a corner portion of the door;

FIG. 7 is an enlarged view taken generally along the line 7-7 in FIG. 6;

FIG. 8 is an enlarged assembly view taken generally along line 8-8 in FIG. 1 of the hinge interconnection between the jamb assembly and the door;

FIG. 9 is an enlarged view taken generally along line 9-9 in FIG. 1 illustrating an upper connection for the tension spring with the hinge therebelow.

### DETAILED DESCRIPTION OF PREFERRED EMBODIMENT

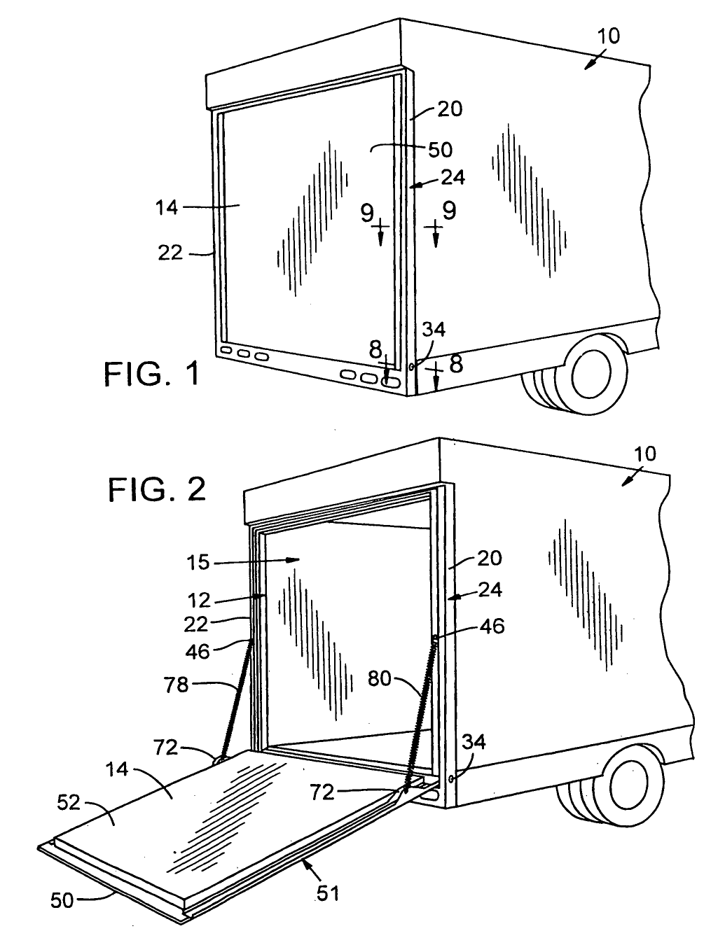

Referring to the drawings, and first more specifically to FIGS. 1 and 2, at 10 is indicated generally a vehicle, such as a recreational trailer. The vehicle has a rear door opening 12 permitting access into a storage chamber, or region, 15. A substantially planer drop down door 14 is shiftable between a closed position as illustrated if FIG. 1 and an open position illustrated in FIG. 2 wherein it allows access to the storage chamber and also may act as a ramp for moving items into the storage region.

The door opening is formed by a door frame 20 having a pair of spaced apart, substantially upright jamb members 22, 24. The jamb members are substantially similar, and thus only one will be described in detail.

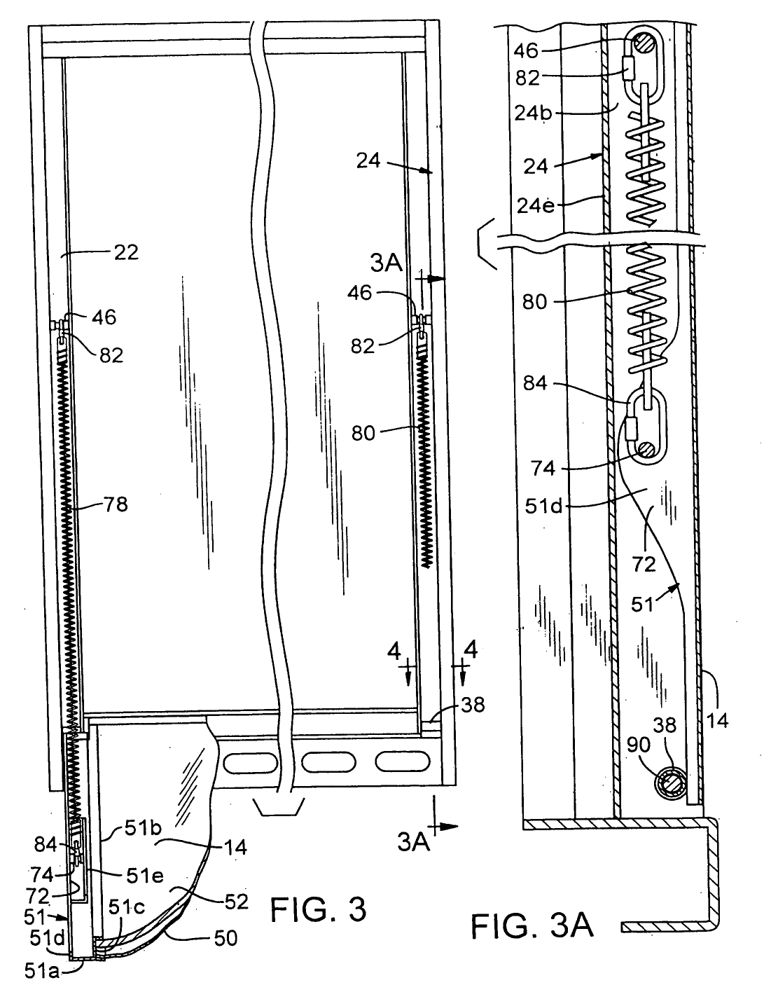

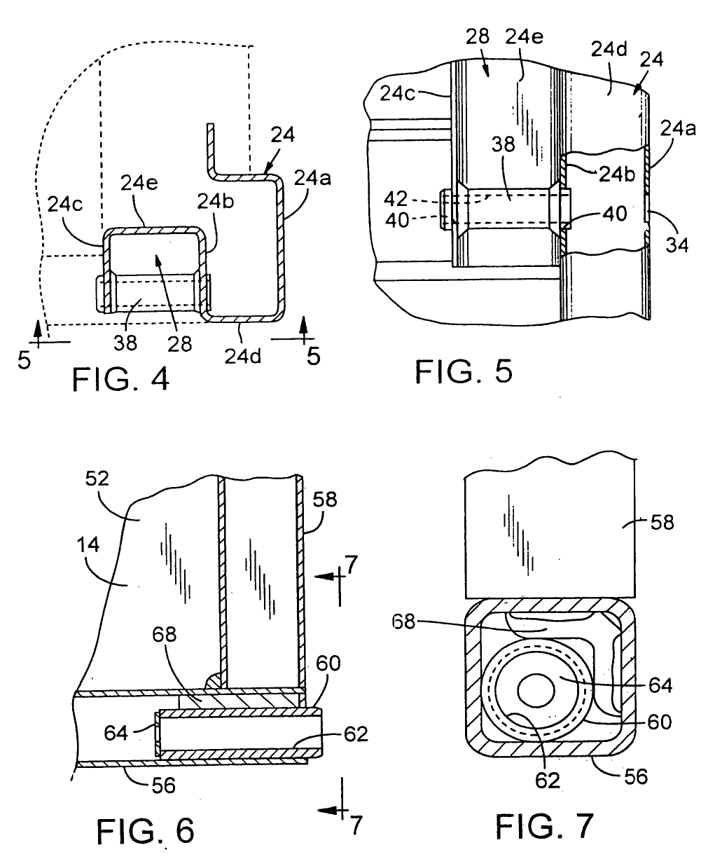

Describing jamb member 24, and referring to FIGS. 3-5, the jamb member includes an elongate formed channel member having substantially parallel, laterally spaced planer side plate portions, or side walls, 24a, 24b, 24c, respectively. The outer edge margins of portions 24a, 24b are interconnected by a planer front plate portion 24d and the inner edge margins of portions 24b, 24c are connected by a planer back plate portion 24e. An elongate channel 28 bounded by portions 24b, 24c, 24e extends vertically within jamb member 24 substantially the full height of this elongate jamb member. A similar channel is formed in jamb member 22. As best seen in FIGS. 5 and 8, an assembly bore 34 extends through side plate portion 24a in the position illustrated.

Adjacent the bottom of jamb member 24, a horizontally disposed cylindrical sleeve 38 extends through receiving bores 40 in side plate portions 24b, 24c aligned with assembly bore 34. Sleeve 38 is secured adjacent its opposite ends in plate portions 24b, 24c, as by welding. The sleeve has a pin receiving, or hinge, bore 42 extending axially therethrough.

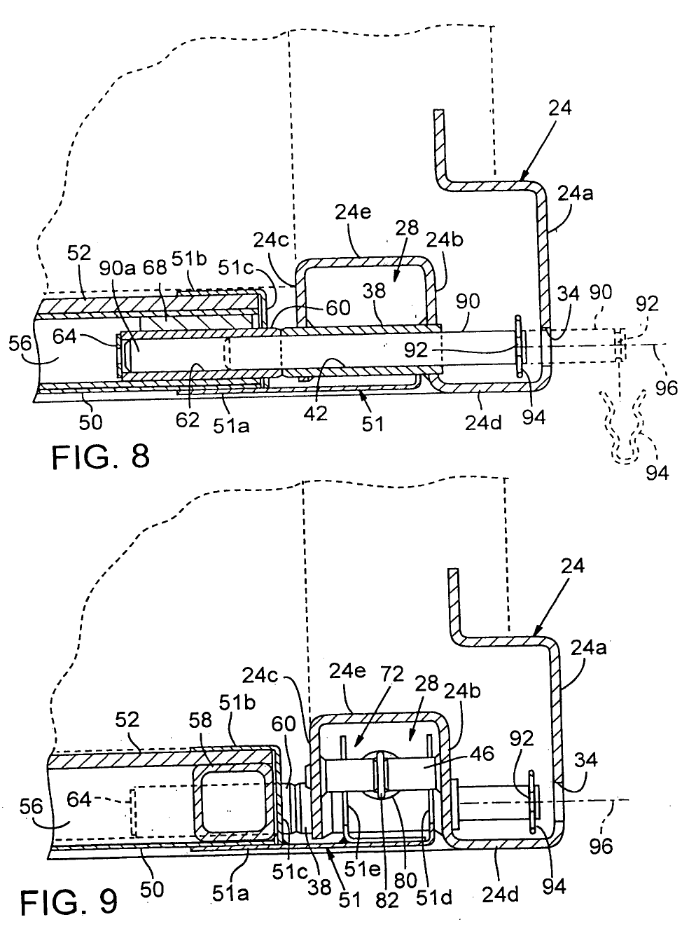

Referring to FIGS. 3, 3A and 9, a coupling pin 46 extends between side plate portions 24b, 24c in a region intermediate the upper and lower ends of jamb member 24, and preferably above the mid-region of jamb member 24, and is secured therein, as by welding. Jamb member 22 is substantially a mirror image of jamb member 24 and has similar bores, sleeve and coupling pin thereon.

Door 14 is formed of a plurality of tubular structural members interconnected in a framework having an outer skin, or covering sheet, 50 secured thereto. An inner covering, or support sheet, 52 covers the inner side of the door framework.

As seen in FIGS. 1, 8, and 9, outer skin, or cover 50 has outer dimensions both width-wise and height-wise, such that it completely encloses opening 12. Opposite edge margins of door 14 have elongate edge frames 51 secured thereto. The configuration of an edge frame 51 is illustrated in FIGS. 2, 3, 3A, 8 and 9. Each edge frame 51 has an elongate outer face plate portion 51a, an inner face plate portion 51b and an edge plate portion 51c extending between portions 51a, 51b. At the outer edge of portion 51a frame 51 is turned in to form a rib portion 51d. Between opposite ends of edge frame 51 rib portion 51d widens as best seen in FIG. 3A. An uprights leg 51e of an angle member is secured to and projects inwardly from portion 51a. Leg 51e is spaced laterally from the widened part of portion 51d, mirrors the widened part, and together they form U-shaped coupling bracket 72.

As best seen in FIGS. 8, 9 face plate portions 51a of edge frames 51 extend over the channels, such as that indicated at 28, in door jamb members 22, 24. This may be seen in FIGS. 8 and 9 where the outer edge margin of face plate portion 51a is shown extending past an outer edge margin of side plate portion 24c of jamb member 24 to a region closely adjacent side plate portion 24b and enclosing the otherwise open front portion of channel 28.

Referring more specifically to FIGS. 6 and 7, a portion of the frame of door 14 is shown as having a substantially horizontally disposed square tube bottom member 56 and an elongate side, or support, member 58 disposed normal to member 56. The bottom member and side member are secured together, as by welding, to form a portion of the rectangular support frame for door 14.

An elongate horizontally disposed cylindrical sleeve 60 is secured, as by welding, in an end portion of bottom member 56 and has an end margin portion extending outwardly a short distance from the end of bottom member 56. Sleeve 60 has a pin receiving, or hinge, bore 62 extending therethrough. An end plate, or stop member, 64 is secured, as by welding, to the inner end of sleeve 60.

As is best seen in FIG. 7, since sleeve 60 is somewhat smaller than the interior dimensions of bottom member 56, a supplemental piece of angle material 68 is secured, as by welding, in bottom member 56 to support sleeve 60 therein.

As possibly best illustrated in FIGS. 8 and 9, when the door is in an assembled position relative to the door frame, sleeves 38, 60 are substantially axially aligned and have adjacent contiguous ends. Their axially aligned bores 42, 62 also are aligned with assembly bore 34.

An elongate hinge pin 90 is provided having a cylindrical outer surface which may be slidably and rotatably received in bores 42, 62 and may be inserted through assembly bore 34. Sleeves 38, 60 have a combined length as seen in FIG. 8 and pin 90 is longer than this combined length. The pin 90 is shown in fully assembled position in solid outline and at an intermediate point in its assembly in dashed outline. As seen in the dashed outline portion, the head end of pin 90 has an annular groove 92 formed therein. This annular groove is adapted to receive a spring clip 94 which is shown in dashed outline in FIG. 8 prior to assembly, and in solid outline in FIGS. 8 and 9 assembled on the head end of the pin in groove 92. As seen in FIG. 8, when fully assembled, the lead end 90a of pin 90 rests adjacent stop plate 64 and is prevented from further insertion. Spring clip 94 held in groove 92 as illustrated in solid outline of FIGS. 8 and 9, is larger than bore 34 and prevents the pin 90 from being retracted back through assembly bore 34, such that pin 90 now is held in position to act as a pivot pin having an axis about which door 14 may be swung between its closed position as illustrated in FIG. 1 and its open position illustrated in FIG. 2. The horizontally disposed pivot axis provided by hinge pin 90 and sleeves 38, 60 is indicated generally at 96 in FIGS. 8, 9.

Referring to FIGS. 2, 3A and 9, connecting, or coupling, brackets 72 are secured to opposite edge margins of door 50 spaced a distance form the bottom edge margin of the door. The coupling brackets are somewhat U-shaped in cross-section as illustrated in FIG. 9, and have a coupling pin 74 (see FIGS. 3, 3A) extending between opposite legs of the U-shaped bracket and secured therein, as by welding.

A pair of elongate tension springs 78, 80 are interconnected between door jambs 22, 24 and opposite side margins of door 14 as best illustrated in FIGS. 2, 3, 3A and 9. As best seen in FIG. 3A, ring couplers 82 adjacent the upper ends of both of springs 78, 80 connects the upper ends of the springs to coupling pins 46 in the jamb members, and second ring couplers 84 connect the lower ends of the springs to coupling pins 74 on the door. As previously noted, a major portion of door 14 has been broken away in FIG. 3 for purposes of displaying portions of the structure, but it should be recognized that although only one of the ring couplers 84 is shown at the lower end of spring 78, a similar bracket and ring coupler interconnection would be provided for the lower end of spring 80 at the right side of FIG. 3 as is well illustrated in FIG. 3A.

Referring to FIGS. 3, 3A and 9, when the door is closed, channel portion 28 of each of the jamb members 22, 24 provides a spring-receiving channel in which the respective tension springs 78, 80 may be received. When the springs are so received in channels 28 and the door is closed as illustrated in FIGS. 3A and 9, a portion of the door in the form of edge frame 51, covers the outer portion of channel 28, the springs 78, 80 lie enclosed and substantially parallel to their associated jamb members in the channels 28, and are covered both for aesthetics and protection of such mechanism. Although an edge frame construction is illustrated herein, it should be recognized that other door construction is also possible to enclose the channel, such as having the door skin 50 extending outwardly to cover the channel.

When the door is swung downwardly from the position illustrated in FIG. 1 toward the position illustrated in FIG. 2, tension springs 78, 80 are extended to aid in control of lowering of the weight of the door, such that they extend downwardly and outwardly at an angle relative to their respective door jamb members 22, 24. Further, upon closing the door, the springs serve to assist in raising the weight of the door.

Although the apparatus has been described in its preferred embodiment with the spring-receiving channel in the jamb member, it should be recognized that the apparatus also might be constructed with the spring-receiving channel formed in an edge margin portion of the door.

Thus, a drop down door system is provided wherein springs are provided for assisting in lowering and raising of the door, yet wherein the springs are enclosed within receiving channels and protected by the closed door. Further, a hinge mechanism is provided which is structurally sufficient for the purpose of supporting the door, yet which may be easily assembled and disassembled as necessary.

Whereas a preferred embodiment of the invention has been described herein, it should be apparent to those skilled in the art that variations and modifications are possible without departing from the spirit of the invention and as set out in the accompanying claims.

1. A drop down door system for a vehicle comprising
a door frame comprising a substantially upright jamb member adjacent one side thereof,
a door having a support member adjacent one side thereof,
hinge mechanism supporting a lower edge portion of said door permitting swinging of the door about a substantially horizontal pivot axis between a closed position wherein said support member is adjacent said jamb member and a lowered open position, and
an elongate spring coupled adjacent one of its ends to said jamb member and adjacent its opposite end to said support member, said spring being extended when said door is in said open position and being contracted when said door is in said closed position,
one of said jamb member or support member having a spring receiving channel formed therein in which said spring rests when it is contracted.

2. The door system of claim 1, wherein said channel is formed in said jamb member and a portion of said door covers said channel when the door is in its closed position.

3. The door system of claim 2, wherein said jamb member comprises an elongate channel shaped member.

4. The door system of claim 1, wherein said jamb member has a selected height and has a spring connector thereon to which said one end of said spring is coupled at a position in said jamb member above a mid-point of said selected height.

5. The door system of claim 4, wherein said support member is elongate and said opposite end of the spring is coupled to said support member in a region intermediate opposite ends of said support member.

6. The door system of claim 1, wherein said member having said spring receiving channel formed therein comprises an elongate member and said spring extends substantially parallel to said member when it rests in said channel.

7. The door system of claim 6, wherein said spring extends outwardly at an angle relative to said member when in its extended position.

8. The door system of claim 1, wherein said spring comprises a tension spring.

9. The door system of claim 1, wherein said hinge mechanism comprises a first horizontally disposed cylindrical sleeve having a hinge bore therein secured to a lower end portion of said jamb member, a second horizontally disposed cylindrical sleeve having a hinge bore therein secured to said lower edge portion of said door, said first sleeve and second sleeve being disposed adjacent each other with their respective hinge bores axially aligned, and an elongate hinge pin is received in said hinge bores.

10. The door system of claim 9, wherein said jamb member has a side wall spaced axially outwardly from said first sleeve, said side wall has on assembly bore formed therein aligned axially with said hinge bores, and said hinge pin is inserted axially through said assembly bore into said hinge bores.

11. The door system of claim 10, which further comprises securing mechanism operable to inhibit removal of said hinge pin from said hinge bores.

12. The door system of claim 11, wherein said securing mechanism comprises a securing clip which is larger than said assembly bore and is connected to said hinge pin between said sleeves and said side wall.

13. The door system of claim 12, wherein said hinge pin has an annular groove formed therein and said securing clip is received and held in said groove.

14. The door system of claim 12, wherein said first and second sleeves have a selected combined length when axially aligned, said hinge pin has a lead end and an opposed head end and is longer than said combined length, and which further comprises mechanism operable to inhibit axial movement of said hinge pin in the direction of said lead end to retain the head end between said side wall and an end of a sleeve nearest said side wall.

15. The door system of claim 14, wherein said limit mechanism comprises a blocking element adjacent an end of second sleeve.

16. A drop down door system for a vehicle comprising
a door frame comprising a substantially upright jamb member adjacent one side thereof,
a door having a support member adjacent one side thereof, and
hinge mechanism supporting a lower edge portion of said door permitting swinging of the door about a substantially horizontal pivot axis between a closed position wherein said support member is adjacent said jamb member and a lowered open position, said hinge mechanism comprising a first horizontally disposed cylindrical sleeve having a hinge bore therein secured to a lower end portion of said jamb member, a second horizontally disposed cylindrical sleeve having a hinge bore therein secured to said lower edge portion of said door, said first sleeve and second sleeve being disposed adjacent each other with their respective hinge bores axially aligned, and an elongate hinge pin is received in said hinge bores.

17. The door system of claim 16, wherein said jamb member has a side wall spaced axially outwardly from said first sleeve, said side wall has on assembly bore formed therein aligned axially with said hinge bores, and said hinge pin is inserted axially through said assembly bore into said hinge bores.

18. The door system of claim 17, which further comprises securing mechanism operable to inhibit removal of said hinge pin from said hinge bores.

19. The door system of claim 18, wherein said securing mechanism comprises a securing clip which is larger than said assembly bore and is connected to said hinge pin between said sleeves and said side wall.

20. The door system of claim 19, wherein said hinge pin has an annular groove formed therein and said securing clip is received and held in said groove.

21. The door system of claim 16, wherein said first and second sleeves have a selected combined length when axially aligned, said hinge pin has a lead end and an opposed head end and is longer than said combined length, and which further comprises mechanism operable to inhibit axial movement of said hinge pin in the direction of said lead end to retain the head end between said side wall and an end of a sleeve nearest said side wall.

22. The door system of claim 21, wherein said limit mechanism comprises a blocking element adjacent an end of second sleeve.

23. A drop down door system for a vehicle comprising
a door frame comprising a substantially upright jamb member adjacent one side thereof,
a door having a support member adjacent one side thereof,
hinge mechanism supporting a lower edge portion of said door permitting swinging of the door about a substantially horizontal pivot axis between a closed position wherein said support member is adjacent said jamb member and a lowered open position, said hinge mechanism comprising a first horizontally disposed cylindrical sleeve having a hinge bore therein secured to a lower end portion of said jamb member, a second horizontally disposed cylindrical sleeve having a hinge bore therein secured to said lower edge portion of said door, said first and second sleeves being disposed adjacent each other with their respective hinge bores axially aligned, and an elongate hinge pin is received in said hinge bores, and
an elongate spring coupled adjacent one of its ends to said jamb member and adjacent its opposite end to said support member, said spring being extended when said door is in said open position and being contracted when said door is in said closed position,
said jamb member comprises an elongate member having a spring receiving channel formed therein in which said spring rests when it is contracted with said spring extending substantially parallel to said jamb member when it rests in said channel and a portion of said door covers said channel when the door is in its closed position.

24. The door system of claim 23, wherein said jamb member comprises an elongate channel shaped member.

25. The door system of claim 23, wherein said jamb member has a selected height and has a spring connector thereon to which said one end of said spring is coupled at a position in said jamb member above a mid-point of said selected height, and said support member is elongate and said opposite end of the spring is coupled to said support member in a region intermediate opposite ends of said support member.

26. The door system of claim 25, wherein said spring extends outwardly at an angle relative to said member when in its extended position.

27. The door system of claim 23, wherein said jamb member has a side wall spaced axially outwardly from said first sleeve, said side wall has on assembly bore formed therein aligned axially with said hinge bores, and said hinge pin is inserted axially through said assembly bore into said hinge bores.

28. The door system of claim 27, which further comprises securing mechanism operable to inhibit removal of said hinge pin from said hinge bores.

29. The door system of claim 28, wherein said securing mechanism comprises a securing clip which is larger than said assembly bore and is connected to said hinge pin between said sleeves and said side wall.
